(19) United States
(12) Patent Application Publication
(10) Pub. No.: US 2005/0056983 A1
(43) Pub. Date: Mar. 17, 2005

(54) Bushing with controlled elastic absorption of radial stress

(76) Inventor: Giuseppe Spinella, Zingonia di Ciserano (IT)

Correspondence Address: YOUNG & THOMPSON, 745 SOUTH 23RD STREET, 2ND FLOOR, ARLINGTON, VA, 22202, US

(21) Appl. No.: 10/471,426

(22) PCT Filed: Jul. 25, 2001
(86) PCT No.: PCT/IT01/00397

(30) Foreign Application Priority Data
Mar. 12, 2001 (IT) CR2001U000001

(51) Int. Cl. B60G 11/22; F16F 1/44

(52) U.S. Cl. 267/293

(57) ABSTRACT

Bushing, in particular of the kind with controlled elastic absorption of radial stress, includes a cylindrical tubular element (1) out of self-lubricating material onto which a ring (2) is freely fitted out of an elastically buckling material, wherein the internal surface of the ring out of elastically buckling material is associated to an annular reinforcing fitting (3) out of a material that does not give radially and which gives the bushing the required radial stiffness and limits the longitudinal deformations of the ring (2).

The present invention concerns a bushing with elastic absorption of radial stress with a control means for the radial compressibility.

Bushings with elastic absorption of radial stress are used for the connection to an axis of a pin, subject to a shifting angular to said axis. They are also used in many fields and among these the one of haulage vehicles. Here they are employed, e.g., for the connection of the leaf spring eye of the back suspension to the undercarriage of the vehicle, or also for the connection of the supporting arms of the front wheels to the undercarriage as well as to the hub of said wheels, or still in the connection of connecting rods, arms etc.

Usually, such bushings are realized by means of two tubular, cylindrical and coaxial elements out of metal; between said elements, an elastic rubber ring is placed, coupled to the same by means of vulcanization. The reciprocal angular shifting of the elements connected by the bushing is allowed by the torsional buckling of the rubber ring, which at the same time produces the effect of absorbing possible direct crashes and radial stress. The assembling takes place by fixing, by interference, the outer tubular element to an appropriate housing, while the pin gets fixed into the inner tubular element, always by interference.

This kind of bushing has a number of inconveniences, among which the breaking of the rubber ring caused by torsional stress; the need of expensive mechanical working of the metal surfaces that must be coupled by interference; the assembling difficulty; the high weight and cost of the bushing due to the necessary mechanic working and to the vulcanization process of the rubber ring.

For solving in particular the first one of said inconveniences, i.e. the fatigue failure of the rubber ring, a bushing is known mainly comprising an internal cylindrical tubular element, out of self-lubricating material. On said tubular element an elastic rubber ring is freely fitted and gets fixed by means of vulcanization to an outer cylindrical tubular element, realized out of metal and coaxial to the first one. The assembling of said bushing takes place, in this case, by fixing by interference the outer cylindrical tubular element to the assembling seat, after boring the latter, while the pin is free to rotate onto the internal surface of the element out of self-lubricating material.

Consequently, it won't transmit any torsional stress to the rubber ring, and the latter has the only task of absorbing the pushes and the stress in radial direction. This mentioned solution eliminates the risk of torsional fatigue failure of the rubber ring and increases the reliability and the life of said bushing; furthermore, it does not request the fixing by interference of the pin to the internal cylindrical tubular element of said bushing. However, said solution does not eliminate the inconveniences linked to the need of preparing for said bushing a seat for the interference assembling of the outer metal tubular element, with consequent high costs due to the mechanical working, to the difficulty of said assembling, to the high weight and cost of said bushing.

Furthermore, from Utility Model application no. CR97U000005 filed on Apr. 17, 1997 of the same applicant, a particular kind of bushing is known, mainly comprising an inner cylindrical tubular element out of self-lubricating material, onto which a ring out of rubber or of any other elastically buckling material is freely fitted. The outer cylindrical surface of said ring is provided with rises that allow the interference assembling of said rubber ring directly into the housing seat of said bushing, without particular working or preparation of the latter.

This kind of bushing shows the advantage of having a simple and saving realization: in fact, it does not need the outer cylindrical tubular element fixed by means of vulcanization to the rubber ring, and does not need special mechanical working. The assembling of the bushing takes place by forcing the buckling rubber ring into its housing seat, is greatly simplified with respect to the reciprocal forcing of metal parts. Furthermore, the mechanical working of said housing seat requires less limiting dimensional tolerances and therefore is less expensive.

However, this kind of bushing has the disadvantage that it is not suitable for those application that require a high radial stiffness and the capacity of bearing great radial loads. As an example: if said bushings are used on haulage vehicles for the connection of the leaf springs of the back suspensions of the undercarriage of the vehicle, they may be applied only to vehicle with a capacity up to about 10 tons. A further inconvenience consists in that in the presence of great radial loads, the rubber ring is subject to relevant buckling in longitudinal direction that may cause expansion and stretching of the rubber, that reduce durability and reliability of said bushing.

It is the aim of the present invention to eliminate all above mentioned inconveniences.

In particular, it is the aim of the present invention to realize a bushing with elastic absorption of radial stress that allows the control of the radial compressibility, and that may sustain radial loads of considerable entity in a reliable manner, and that the realization thereof is convenient and the assembly easy.

The aims set forth are reached by means of a bushing with elastic absorption of radial stress with a control means for the radial compressibility according to the present invention, comprising a cylindrical tubular element out of self-lubricating material onto which a ring is freely fitted out of a elastically budding material, characterized in that the internal surface of said ring out of elastically buckling material is associated to an annular reinforcing fitting out of a material that does not give radially.

For making the coupling between the bushing and the circular seat into which it gets inserted as less expensive as possible, the outer surface of said ring out of elastically buckling material comprises bulge ribbings that cooperate in interference with the internal surface of said seat.

Said ring out of elastically buckling material may be advantageously realized out of rubber, while said reinforcing annular insert is advantageously realized out of glass loaded nylon; its thickness is correlated to the entity of the radial charges to bear and is coupled by means of vulcanization to the internal surface of the rubber ring.

Said bulge ribbings on the outer surface of the ring out of buckling material, according to the cited Utility Model of the same applicant, are advantageously placed at regular distances one from the other and in a longitudinal direction, parallel to the axis of the bushing. In an alternative, bulges with annular shape, parallel one to the other, might perform the same function.

The main advantages obtained by means of the bushing with elastic absorption of radial stress with a control means for the radial compressibility according to the present invention consist in that said bushing is able to bear high radial loads due to the control of the radial buckling assured by the reinforcing insert, and in that the reinforcing insert, connected by vulcanization to the internal surface of said rubber ring, limits and contains the longitudinal buckling of said ring. A further advantage consists in that by suitably choosing the thickness of the internal reinforcing insert, it is possible to realize bushings with different degrees of radial stiffness, fitting to different application fields.

The present invention will be explained more in detail hereinbelow relating to the enclosed drawings in which an embodiment is shown.

FIG. 1 shows a perspective view of a bushing with elastic absorption of radial stress With a control means for the radial compressibility, according to the present invention.

FIG. 2 shows said bushing in an axial section.

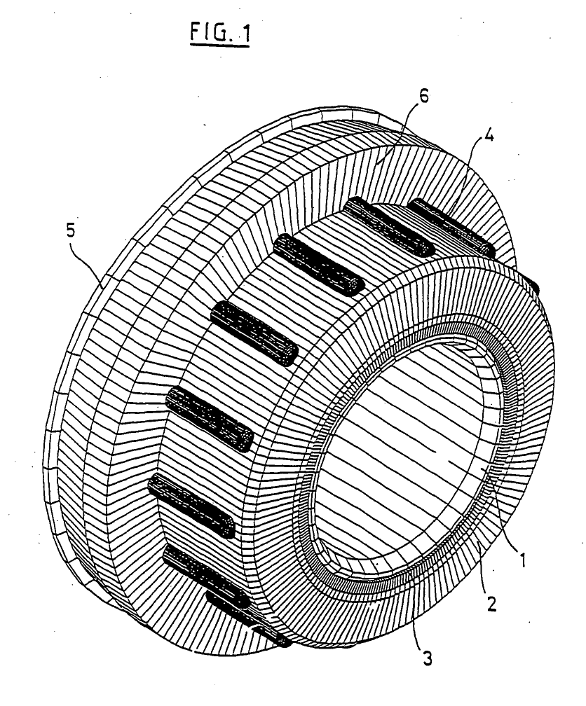

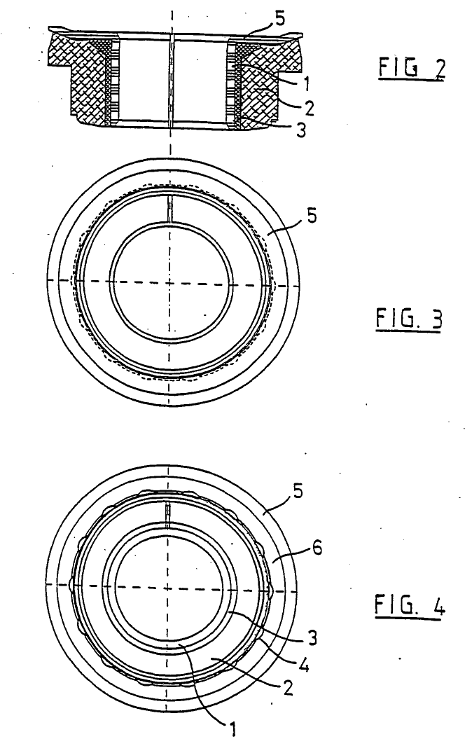

FIGS. 3 and 4 show said bushing in a top and a bottom view.

Relating now to the drawings, the bushing with elastic absorption of radial stress with a control means for the radial compressibility according to the present invention mainly comprises an internal cylindrical tubular element 1 out of plastic self-lubricating material, onto which a rubber ring 2 is freely fitted. An annular reinforcement 3 of suitable thickness is fixed on the internal cylindrical surface of said rubber ring 2, and it is out of a material that does not give radially, like e.g. glass loaded nylon. The coupling between said ring 2 and said reinforcement 3 is advantageously realized by means of a vulcanization process.

The external cylindrical surface of said ring 2 has a plurality of bulge ribbings 4 that locally increase the thickness of said ring 2.

Furthermore, in the embodiment shown, element 1 and ring 2 have stop collars 5 and 6 that allow the bushing to bear the compression stress parallel to the axis of said bushing. In addition, it is possible to place a plane metal washer—not shown—of suitable thickness, similar to the one of collars 5 and 6, against said collar 6: said washer allows to distribute the longitudinal force transmitted to the bushing onto a greater surface and in a uniform manner, thus increasing the resistance of said bushing to said compression stress. It is evident that any variant of the bushing according to the present invention, of generic or simplified kind, will not be provided with said collars 5 and 6.

The assembling of the bushing according to the present invention takes place by pushing the external surface of said rubber ring 2 into the housing seat of said bushing. During such operation, the bulge ribbings 4 get compressed and elastically buckled, while the space between one ribbing and the other allows a free lateral extension of the same. Thus the bushing will be fixed in its own seat by the friction between the buckled rubber bulges and the internal surface of the housing seat. The pin in freely rotating on the internal surface of said tubular element 1.

During normal working, said rubber ring 2 absorbs crashes and radial stress transmitted by the pin to the bushing, while the annular reinforcement 3 of suitable thickness gives the bushing the required radial stiffness, limits its squeezing and the longitudinal deformation of the rubber ring 2.

1. A bushing, in particular of the kind with controlled elastic absorption of radial stress, comprising a cylindrical tubular element (1) out of self-lubricating material onto which a ring (2) is freely fitted out of a elastically buckling material, characterized in that the internal surface of said ring out of elastically buckling material is associated to an annular reinforcing fitting (3) out of a material that does not give radially.

2. A bushing according to claim 1, characterized in that the external surface of said ring (2) out of elastically buckling material comprises bulge ribbings (4).

3. A bushing according to claim 1, characterized in that said bulge ribbings (4) are placed at regular distances one from the other.

4. A bushing according to claim 1, characterized in that said bulge ribbings (4) develop in a longitudinal direction substantially parallel to the axis of said bushing.

5. A bushing according to claim 1, characterized in that said bulge ribbings (4) have an annular shape.

6. A bushing according to claim 1, characterized in that said ring (2) is out of rubber.

7. A bushing according to claim 1, characterized in that said annular reinforcing insert (3) is fixed to said ring (2) by means of vulcanization.

8. A bushing according to claim 1, characterized in that said element (1) and said ring (2) are respectively provided with stop collars (5, 6).

9. A bushing according to claim 1, characterized in that it comprises a plane metal washer that may be placed against said stop collar (6).

10. A vehicle characterized in that it comprises at least one bushing according to claim 1.
